(19) United States
(12) Patent Application Publication
(10) Pub. No.: US 2026/0265847 A1
(43) Pub. Date: Sep. 10, 2026

(54) PLANT AND MEHTOD FOR THE PRODUCTION OF DIRECT REDUCED IRON

(71) Applicants: Danieli & C. Officine Meccaniche S.P.A., Buttrio (UD) (IT); HYL TECHNOLOGIES, SA DE C.V., SAN NICOLAS DE LOS GARZA, NUEVO LEON (MX)

(72) Inventors: Andrea TAVANO, TAVAGNACCO (UD) (IT); Alberto ZUGLIANO, MANZANO (UD) (IT); Stefano MAGGIOLINO, SAN PEDRO GARZA GARCIA, NUEVO LEON (MX); Jorge Eugenio MARTINEZ MIRAMONTES, GENERAL ESCOBEDO, NUEVO LEON (MX)

(21) Appl. No.: 19/121,954

(22) PCT Filed: Oct. 20, 2023
(86) PCT No.: PCT/IT2023/050233

§ 371 Date: Apr. 17, 2025

(30) Foreign Application Priority Data
Oct. 20, 2022 (IT) IT102022000021630

(51) Int. Cl. C21B 13/02; C21B 13/00

(52) U.S. Cl. CPC C21B 13/02; C21B 13/0073; C21B 2100/22; C21B 2100/44; C21B 2100/66; C21B 2200/00

(57) ABSTRACT

A direct reduction plant (10) for a direct reduction of iron oxides to produce a DRI product, comprising a reactor (11), configured to being loaded with said iron oxides, a reduction circuit (19) fluidically connected to said reactor (11), a hydrogen generator (31) able to generate a make-up gas comprising hydrogen gas and configured to receive hydrocarbons as a feed and generate, in absence of oxidant agents, said make-up gas and a product comprising carbon in solid phase. The product comprising carbon is used, inside an electric arc furnace as required for the desired steel production or is mixed with the DRI product to produce HBI products or CBI products with a controlled quantity of carbon.

### FIELD OF THE INVENTION

The present invention relates to a direct reduction plant and relative method, adapted, in particular, for the production of metallic iron by means of direct reduction of iron oxides using a hydrogen-based reducing gas.

### BACKGROUND OF THE INVENTION

Plant of the known type for the production of reduced iron ore (DRI—Direct Reduced Iron), also known as Direct Reduction Plants (DRP), are schematically represented in FIGS. 1, 2 and 3.

Known plants 100 comprise a reactor 111 having a reactor chamber 112 into which iron oxide is loaded, in the form of pellets and/or lump ores M, and a reduction circuit 119 for treating and feeding a reducing gas to the reactor, said reducing gas comprising hydrogen and carbon monoxide and being adapted to reduce said iron oxide in the reactor.

The reducing gas, also called process gas, is injected into the reactor chamber 112 at a high temperature.

The reactor 111 can be of the static-bed type, of the moving-bed type, of the fluidized-bed type, or of the rotary or kiln type.

In a moving-bed reactor, the reducing gas is typically introduced into the central part of the reactor, made to go up in counter-flow through the iron oxide, and then extracted.

The exhaust gas exiting the reactor 111 is de-dusted, deprived of at least part of the reaction products (H₂O and CO₂) and compressed in a recovery and treatment line 120 of the reduction circuit 119, placed downstream of the reactor 111.

The exhaust gas treated is then mixed, in a treatment and feeding line 130 of the reduction circuit 119, with a make-up gas (natural gas, coke oven gas, gas obtained in a reformer, Corex Gas, Syn Gas, etc., in practice any gas holding significant quantities of CH₄ and/or H₂ and/or CO).

For the production/feeding of the make-up gas, known plants can have an off-line reformer device 138 (FIG. 1), no reformer device (FIG. 2), or an in-line reformer device 138 (FIG. 3).

The process gas, defined by the mixture of the make-up gas and the exhaust gas recycled after appropriate treatment, can be sent to a heating unit 137, which brings it to the temperature required by the reduction process, normally above 850° C.

The heated flow of process gas, into which oxygen can be injected with the object of increasing the temperature thereof even further, is sent to the reactor 111 into which the iron oxides to be reduced, in the form of pellets and/or lump ores M, are introduced from above and flow downwardly there-through, while the DRI (reduction product) is extracted at the opposite end of said reactor and sent by a pneumatic transport system, or by gravity, or by conveyors, to a blast furnace or an electric arc furnace or to an oxygen converter or to any device able to melt the produced DRI.

In greater detail, in the iron oxide direct reduction process, the oxygen is removed from the iron ore by means of chemical reactions with hydrogen and/or carbon monoxide, in order to obtain DRI with a high level of metallization (ratio between metallic iron and total iron contained in the DRI). The overall reduction reactions involved in the process are well-known and they are shown below:

Fe₂O₃ + 3H₂ −> 2Fe + 3H₂O (1)
Fe₂O₃ + 3CO −> 2Fe + 3CO₂ (2).

The hydrogen and carbon monoxide react with the oxygen of the iron oxide and are transformed into water and carbon dioxide according to the reactions (1) and (2). Besides H₂O and CO₂, unreacted H₂ and CO are also present in the exhaust gas exiting the reactor.

The exhaust gas is treated as described above with the object of recovering these reducers.

The use of a make-up gas fed to the reduction circuit 119 containing a significant amount of carbon (a gaseous hydrocarbon-containing gas such as Natural Gas, Coke Oven Gas, Corex Gas, SynGas etc.) has the main disadvantage of producing a high quantity of greenhouse gas emissions (CO₂). In some plants like those illustrated in FIGS. 1-2 a CO₂ removal device 140 and a humidifier device 141 are incorporated in the reduction circuit 119 and permit the controlled extraction and sequestration of the CO2 emissions, while in plants like those illustrated in FIG. 3, the CO2 is emitted to the atmosphere. (see FIGS. 2 and 3).

In addition, a relatively high content of carbon monoxide (CO) in the flow of reducing gas entering the reactor can result in a relatively high fines production during the reduction reaction and, because of the increase in temperature due to the reduction with carbon monoxide, which is exothermic, this can increase the risk of generating clusters, hindering the movement of the solid mass.

In the scheme of currently-used processes having no reformer or an off-line reformer, the CO₂ emissions are reduced by the selective removal of CO₂ from the exhaust gas recycled to the reactor, and such emissions are reduced only to the carbon dioxide released through the chimney of a hydrocarbon gas reformer (where present) and/or of the heating unit of the reducing gas.

With respect to other known direct reduction processes, which are supplied with natural gas, to promote methane reforming reactions inside the reduction reactor, or which are supplied with reformed gas produced by an off-line reformer, nonetheless a good H₂/CO ratio in the composition of the reducing gas, which is introduced into the reactor is guaranteed.

At present, a further reduction in CO₂ emissions is extremely difficult using the traditional make up gases.

A simple solution is the substitution of the hydrocarbon-containing make up gas (totally or partially) with hydrogen.

Although the hydrogen can be produced in different ways, green hydrogen is mainly coming from water hydrolysis, which requires high amounts of electrical energy and needs to be fed with demineralized water.

Useless to say that, in absence of a source of cheap and clean electric energy (clean means not having a carbon footprint, thus energy coming from renewable resources), the production of hydrogen from electrolysis can easily turn the overall carbon balance into a scenario similar or even worse than the classic direct use of natural gas inside the DRPs.

There is therefore a need to perfect a plant and a method for the production of direct reduced iron that can overcome at least one of the disadvantages of the state of the art.

One purpose of the present invention is to provide an alternative in the hydrogen production suitable for a direct use inside a DRP, without the need of relying on a source of clean electric energy.

Another purpose of the present invention is to provide a DRP with very low carbon dioxide emission.

Another purpose of the present invention is to provide a DRP with a limited number of components and having low management cost.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, and to resolve the technical problem disclosed above in a new and original way, also achieving considerable advantages compared to the state of the prior art, a direct reduction plant, according to the present invention, for a direct reduction of iron oxides to produce a DRI product, comprises a reactor configured to being loaded with iron oxides, and a reduction circuit fluidically connected to said reactor, wherein the reduction circuit comprises:
a recovery and treatment line, placed downstream of said reactor for recovering and treating an exhaust gas exiting said reactor;
a treatment and feeding line, placed upstream of said reactor, for feeding a process gas, comprising said exhaust gas previously treated and a make-up gas, to said reactor;
a hydrogen generator able to generate said make-up gas.

In accordance with one aspect of the present invention, said hydrogen generator is configured to receive hydrocarbons as a feed and generate, in absence of oxidant agents, both said make-up gas, that fully or partly comprises hydrogen gas, and a product comprising carbon in solid phase.

In accordance with another aspect of the present invention, said hydrogen generator comprises a reactor chamber where a cracking reaction occurs, a fuel feeder device configured to feed a hydrocarbon fuel to said reactor chamber, an energy feeder device configured to provide energy to said reactor chamber, and/or a catalyst feeder device configured to provide a catalyst to said reactor chamber.

In accordance with another aspect of the present invention, said energy feeder device can be chosen in a group comprising a burner configured to burn part of the fuel or part of the produced hydrogen, a solar device configured to concentrate solar power in said reactor chamber, or an electric device both for the indirect heating of the fuel or to directly enhance the reaction in said reactor chamber.

In accordance with another aspect of the present invention, said catalyst feeder device can be chosen in a group comprising a solid metal catalyst feeder, a carbonaceous catalyst feeder, a molten metal feeder, a molten salt feeder.

In accordance with another aspect of the present invention, the plant comprises a mixer device placed downstream of said reactor for mixing part of said product comprising carbon with the hot DRI product. The mixer device may be located before the DRI product is fed to a DRI melting unit or said product comprising carbon may be fed directly to said DRI melting unit while the DRI product is processed in said DRI melting unit. The DRI melting unit may be for example an electric arc furnace, or other furnace able to produce molten metal, such as submerged arc furnaces, open slag bath melting furnaces or induction furnaces.

In accordance with another aspect of the present invention, said treatment and feeding line comprises a heating unit placed upstream of said reactor to heat the process gas at a desired process temperature.

According to a variant, said treatment and feeding line comprises a reformer device configured to receive both said exhaust gas, previously treated and compressed, and to provide, as an outcome, said process gas to be sent to said reactor.

The present invention also concerns a direct reduction method for a direct reduction of iron oxides to produce a DRI product, comprising the following steps:
loading a reactor with said iron oxides;
recovering and treating an exhaust gas exiting said reactor;
treating and feeding a process gas to said reactor, said process gas being a mix of said exhaust gas, previously treated, and a make-up gas generated by a hydrogen generator.

In accordance with one aspect of the present invention, said hydrogen generator receives hydrocarbons as a feed and generate, in absence of oxidant agents, both said make-up gas, that fully or partly comprises hydrogen gas, and a product comprising carbon in solid phase.

In accordance with another aspect of the present invention, said make-up gas is generated by cracking hydrocarbons-containing gas or liquid.

In accordance with another aspect of the present invention, said make-up gas is generated by cracking of natural gas, for instance ethane, butane, propane, liquid natural gas and any mixture of them.

In accordance with another aspect of the present invention, said product comprising carbon is a raw material suitable for mechanical construction, not generating any carbon dioxide emission.

In accordance with another aspect of the present invention, said product comprising carbon is stored, underground or above ground, in order to avoid generation of carbon dioxide emissions.

In accordance with another aspect of the present invention, said hydrogen generator uses natural gas or any combustible gas or liquid to provide energy for the cracking reactions.

In accordance with another aspect of the present invention, said hydrogen generator uses part of the produced hydrogen to provide energy for the cracking reactions, thus reducing the carbon footprint.

In accordance with another aspect of the present invention, said hydrogen generator uses electric energy to provide energy for the cracking reactions, thus reducing the carbon footprint.

In accordance with another aspect of the present invention, said product comprising carbon is used, in part, inside an electric arc furnace in order to provide the correct blending for the desired steel production.

In accordance with another aspect of the present invention, said product comprising carbon is used, in part, at the reactor discharge to provide a precise quantity of carbon to the DRI product.

In accordance with another aspect of the present invention, a predetermined amount of said product comprising carbon is mixed with the DRI product by compressing, in hot or cold conditions, in order to produce HBI products (Hot Briquetted Iron) or CBI products (Cold Briquetted Iron).

In accordance with another aspect of the present invention, an injection of carbon containing gas is foreseen at the transition zone of the reactor or in the reactor cone below the reduction zone of said reactor, in order to ensure a certain amount of carbon in the produced DRI.

In accordance with another aspect of the present invention, nitrogen is introduced in the reduction circuit with the purposes to adjust the gas molecular weight, thus facilitating the gas distribution inside the process equipment, and to adjust the thermal energy introduced into the reactor.

The advantages of the present invention are:
a) The hydrogen conversion may not be necessarily full. Also, a residual slip of unreacted hydrocarbons from natural gas can go along with the hydrogen to the DRP. Thus, a full level of conversion is not required. Moreover, a certain quantity of carbon inside the DRI is beneficial for many reasons (higher stability of the product at atmospheric condition, better performance of the electric arc furnace when melting the DRI) thus some residual methane or other hydrocarbons in the hydrogen gas can do this function.
b) The carbon fraction of the natural gas is physically separated from the hydrogen product, potentially up to complete separation. In such a case the carbon footprint of the produced hydrogen is zero even if all the process starts from a fossil fuel.
c) The storage of the solid carbon will be much easier and performing than the present attempts of storing CO₂ underground because:
Carbon mass can be moved through conventional means (trucks, wagons), thus there is no need of pipelines.
For processes like geo storing or enhanced oil recovery (which are the only solutions able to store underground significant quantities of CO₂) CO₂ needs particular reservoirs (in practice depleted gas or oil wells) so it is necessary to deploy long pipelines to reach the proper facilities. Many countries not even have those facilities. Solid carbon storing can instead be applied in any place, potentially in the vicinity of the hydrogen generator and does not need any particular depth of burying. Therefore, transport and storing cost are by far lower.
CO₂ stored needs typically high levels of pressure, higher than 100 bar and often above 200 bar. This aspect represents a significant source of operating costs (compressors and equipment electric energy) as well as huge capital costs for CO₂ treating and compressing. Solid carbon instead (either in the form of fines, flakes or compacted dust) can be easily reclaimed through means like payloaders, not requiring any special technology or expensive dedicated plans.
As numerical example, in the extreme case of pure hydrogen feeding to the DRP, about 700 Nm3 of hydrogen are required to produce one ton of DRI with zero carbon footprint. Producing hydrogen through cracking and reclaiming of solid carbon, this quantity of hydrogen is obtained by 350 Nm3 of methane that brings about 187 kg of carbon mass to be stored. Adding the energy requirements to bring the methane to cracking, the overall consumption shall be in the order of 480 Nm3 of methane per ton of DRI, thus about 250 kg of final carbon mass to be stored. Assuming a density of the product of 2.0 kg per liter, this means about 125 liters of volume occupied by the stored carbon per each ton of DRI.

A conventional DRP natural gas fed equipped with carbon sequestration means (such to not emit any CO2 to the atmosphere) would instead use about 270 Nm3 of methane per ton of DRI. Notwithstanding the lower consumption figure and even considering that in this process some carbon (typically 25 kg per ton of DRI) is actually embedded in the DRI and not emitted out, this production way brings about 230 Nm3 of CO2 per ton of DRI; assuming to compress it to 100 bar to store it underground in supercritical state, this turns into an occupied volume of 1100 liters per ton of produced DRI.

Thus, the volume requirements of storing of the present invention are lower of a factor close to 9 compared to present conventional carbon capture and storage systems.
d) The cracking process of the present invention is generally independent from the availability of renewable energies since all the fossil fuel used would have the greatest part or the totality of its carbon fraction stripped from the fuel before its use. This production way produces in fact green hydrogen while using conventional fossil fuels.
e) The energy for the cracking reactions can also come from electric energy, e.g. plasma cracking. In this case, if a green electricity source is available, the quantity of fresh methane needed to sustain the process is lowered even further, and the amount of carbon to be used/stored diminishes. In this case the methane requirements per ton of DRI would be around 350 Nm3, thus producing around 190 kg of carbon which would take up 95 liters of storing space.

### BRIEF DESCRIPTION OF THE DRAWINGS

These and other aspects, characteristics and advantages the present invention will become apparent from the following description of some embodiments, given as a non-restrictive example with reference to the attached drawings wherein:

FIGS. 1-3 are diagrams showing DRPs of the state of the art;

FIG. 4 is a diagram of a DRP according to the present invention;

FIG. 5 is a diagram of a DRP according to another embodiment of the present invention.

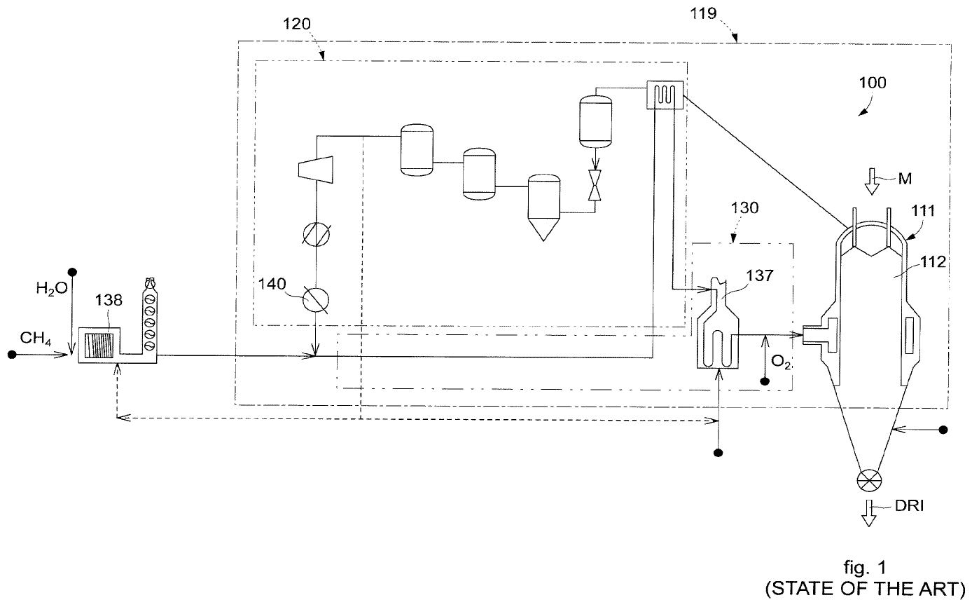

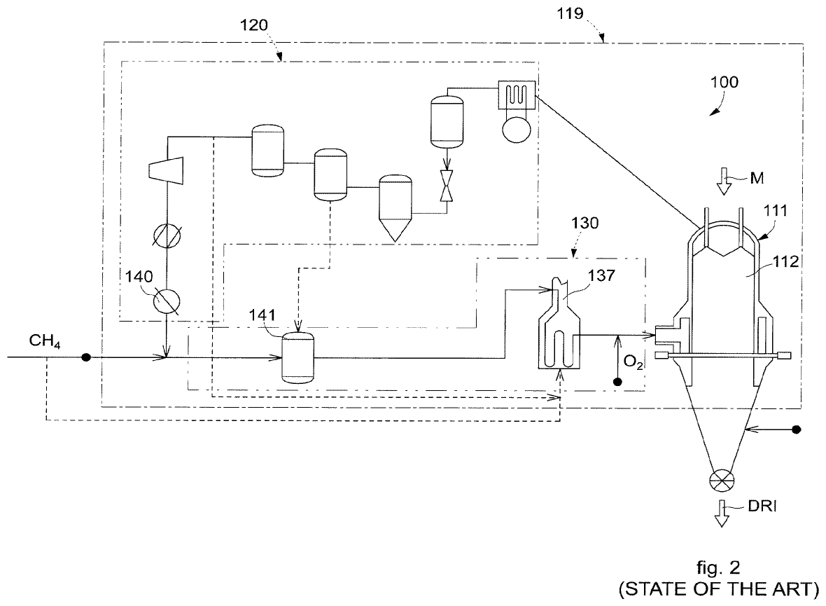

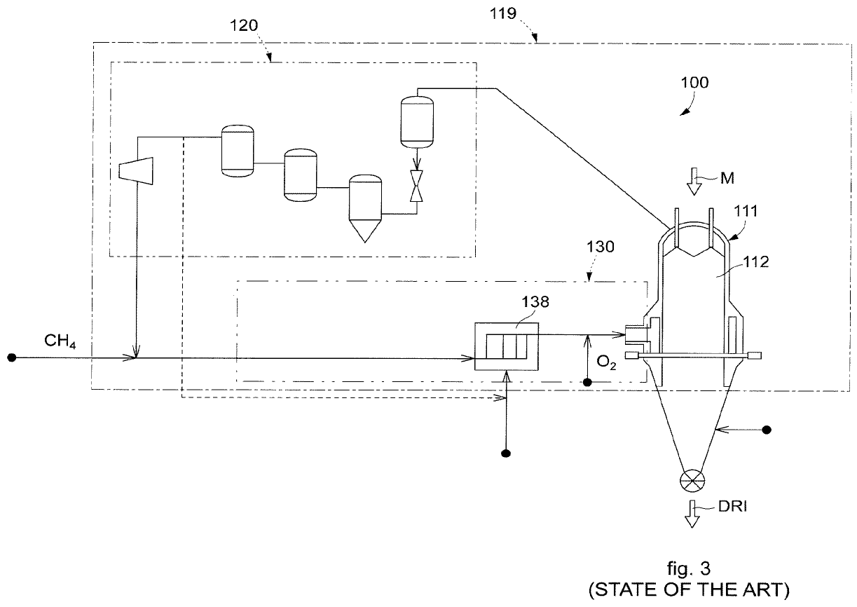

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

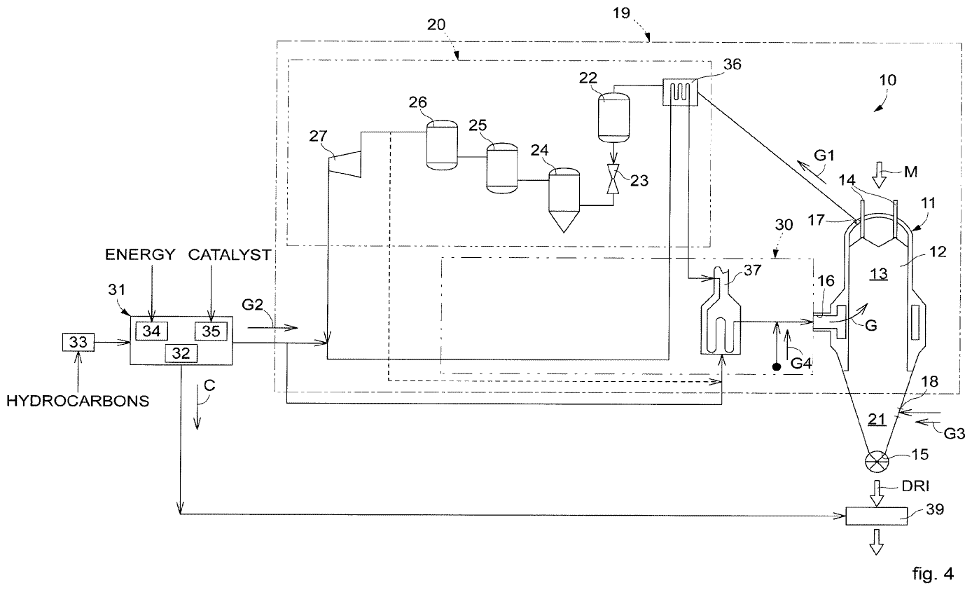

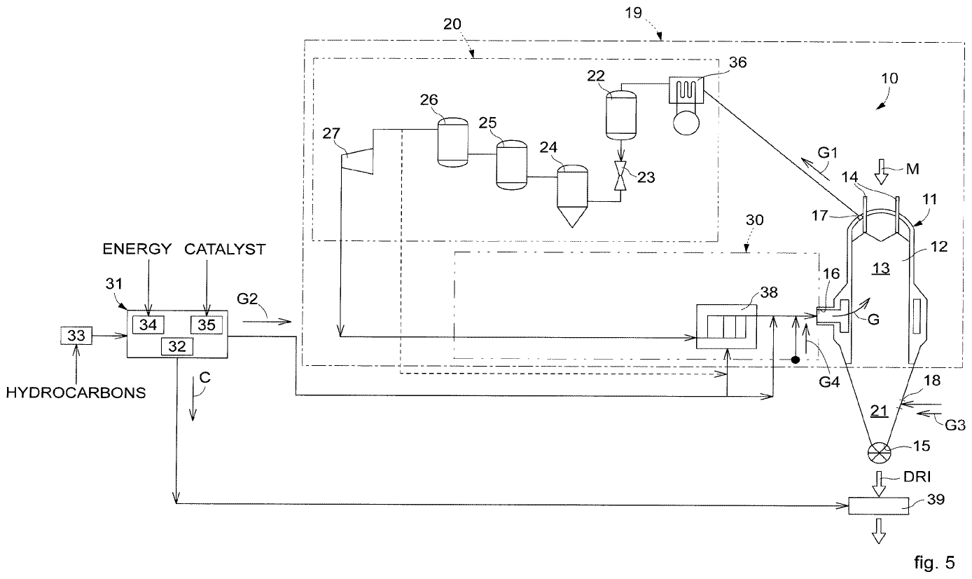

With reference to FIGS. 4 and 5, a direct reduction plant 10 according to the present invention comprises a reactor 11 having a reactor chamber 12, with a reduction zone 13 where takes place the reaction between iron oxides M and a process gas G to obtain a DRI product.

The reactor 11 comprises first inlet ducts 14 for the introduction of the iron oxides M into the reactor chamber 12, and first outlet ducts 15 for the exiting of the DRI product from the reactor chamber 12, as well as second inlet ducts 16 for the introduction of the process gas G into the reactor chamber 12 and second outlet ducts 17 for the exiting of an exhaust gas G1 from the reactor chamber 12.

The reduction zone 13, the first inlet ducts 14 and the second outlet ducts 17 are placed at the top half of the reactor chamber 12 while the second inlet ducts 16 enters the reactor 11 at a central part of the reactor chamber 12.

As an option, the reactor 11 could comprise third inlet ducts 18 for the introduction of a carbon-containing gas G3 directly in the rector chamber 12, below the reduction zone 13, for example at a reactor cone 21, or transition zone, of the reactor 11, with the purpose to introduce some carbon content in the DRI product. For example, the carbon-containing gas G3 could be CH₄, heavier hydrocarbons, etc.

The reactor cone 21 is at the bottom of the reactor chamber 12 where there are also placed the first outlet ducts 15 for discharging the DRI product.

The plant 10 comprises a reduction circuit 19 fluidically connected to the reactor 11 and having a recovery and treatment line 20 and a treatment and feeding line 30.

The recovery and treatment line 20 is placed downstream of the reactor 11 for recovering and treating the exhaust gas G1 exiting the reactor 11. The exhaust gas G1 after the treatment mainly comprises CO₂, H₂O, H₂, CO, CH4 and N₂.

The reduction circuit 19 comprises, at least a device to separate dust entrained in the gas exiting the reactor and separating units to separate the products of the reduction reactions, namely H2O and optionally CO2. In the embodiment illustrated in FIG. 4, the reduction circuit 19 comprises in sequence on the recovery and treatment line 20, known components such as a quench device 22, a venturi nozzle 23, a separator device 24, a gas cooler 25, a knockout drum 26 and a compressor or blower device 27.

The treatment and feeding line 30 is fluidically connected to the recovery and treatment line 20 and placed upstream of the reactor 11 for treating and feeding the process gas G to the reactor 11.

The process gas G is obtained by mixing the exhaust gas G1, previously treated, with a make-up gas G2. The make-up gas G2 mainly comprises hydrogen, but could also comprise some residual hydrocarbons in case of non-complete conversion.

The reduction circuit 19 comprises a hydrogen generator 31 configured to generate said make-up gas G2. The hydrogen generator 31 is fluidically connected to the treatment and feeding line 30.

The reduction circuit 19 may also comprise a heat recuperator 36 configured to extract a heat flux from the exhaust gas G1 exiting the reactor chamber 12.

According to the embodiment of FIG. 4, the heat recuperator 36 forms part of the treatment and feeding line 30 and is able to pre-heat the obtained process gas G performing a heat exchange between the exhaust gas G1 and the process gas G. The reduction circuit 19 also comprises a heating unit 37 disposed on the treatment and feeding line 30 to heat the process gas G, previously pre-heated in the recuperator 36, at a desired process temperature, for example of about 850° C. A further injection of make-up gas G2 (not pre-heated) and exhaust gas G1 (not compressed, see dotted line) is provided to the heating unit 37 as a fuel.

According to another embodiment shown in FIG. 5, the reduction circuit 19 comprises a reformer device 38 disposed on the treatment and feeding line 30 and configured to receive the exhaust gas G1, previously treated and compressed, and to provide, as an outcome, the process gas G to be sent to the reactor 11. Optionally, a further injection of the make-up gas G2 is provided in the process gas G exiting the reformer device 38. A further injection of make-up gas G2 enriched with a flux of exhaust gas G1 (not compressed, see dotted line) is fed to the heating unit 37 as a fuel.

In the embodiment of FIG. 5, the heat recuperator 36, that forms part of the recovery and treatment line 20, does not cooperate with the treatment and feeding line and could have a storage device for a thermal exchange fluid.

Optionally, a further injection of oxygen gas G4 is provided in the process gas G exiting the heating unit 37 (FIG. 4), or the reformer device 38 (FIG. 5), before entering the reactor 11 with the aim to further increase the process gas temperature.

The hydrogen generator 31 is configured to generate said make-up gas G2 based on cracking of hydrocarbons, without reaction with oxidant agents.

More specifically, the hydrogen generator 31 is configured to receive natural gas, and/or other hydrocarbons, as a feed and provide both the make-up gas G2 and a product comprising carbon C in solid phase, also called solid carbon, as a byproduct. Natural gas is typically composed by methane (CH₄) constituting more than 80% of the gas composition. Other heavier hydrocarbons like C₂H₆, C₃H₈, C₄H₁₀ or heavier complement the overall composition along with some residual inert species like N₂ and CO₂.

The hydrogen generator 31 comprises a reaction chamber 32 where a cracking reaction occurs, a fuel feeder device 33 configured to feed a hydrocarbon fuel to said reaction chamber 32, an energy feeder device 34 configured to provide energy to said reaction chamber 32, and/or a catalyst feeder device 35 configured to provide a catalyst to said reaction chamber 32.

There are several ways in which natural gas and other hydrocarbons can be converted into hydrogen and solid carbon C inside the hydrogen generator 31 depending on the type of energy and catalyst feeder devices 34, 35.

The energy feeder device 34 could be chosen in a group comprising a burner configured to burn part of the feed (i.e. natural gas) or part of the produced hydrogen for indirect heating of the feed, a solar device configured to concentrate solar power (direct or indirect), an electric device which can be used both for the indirect heating of the feed or to directly enhance the reaction (such as in plasmolysis, which is plasma-driven pyrolysis).

The catalyst feeder device 35 could be chosen in a group comprising a solid metal catalyst feeder, a carbonaceous catalyst feeder, a molten metal feeder (where metals could be both pure or alloys of a less active, low melting point metal and a more active, high melting temperature one), a molten salt feeder (or dispersion of active catalyst in molten salts).

By focusing on methane for instance, hydrogen can be generated by the following chemical reaction:

CH₄ → C + 2H₂ (3)

In case of heavier hydrocarbons reactions are similar. For instance, ethane can give:

C₂H₆ → 2C + 3H₂ (4)

Above reactions are known as cracking reactions.

Although the cracking process may be not 100% efficient, however the reactor 11 is already suited to work also with a fraction, or the totality, of CH₄, as well as CO, therefore if the generator product is a hydrogen containing gas with a residual slip of unreacted hydrocarbons, this will be easily accepted by the reactor 11 that can process also those gas species.

If the conversion is instead complete without any contamination of the produced hydrogen gas, this will turn into a better result in terms of carbon footprint.

However, different conversions of hydrocarbons can be reached by varying the process parameters such as temperature and pressure. It is well known that hydrocarbons cracking reactions are thermodynamically favored at high temperatures and low pressures.

The result of cracking reactions or the like have the characteristic of releasing the carbon product in solid state. Irrespective of the means (catalytic cracking or thermal cracking), the carbon can be separated from the gaseous hydrogen.

If the process is fully efficient, the result will be pure or almost pure hydrogen from one side and solid carbon C from the other.

The solid carbon C separated from the hydrogen stream can be used in these ways:
the carbon mass may have a mechanical value (carbon black, graphite production, carbon fiber production), thus in this case can be sold as a commercial product not supposed to be burnt, thus not releasing any CO₂ to the environment;
if the carbon mass has no easy use, it can be simply dumped and stored underground (old mines or caves or any suitable location for dumping of big quantities of materials). Also, in this case in fact there is no burning of carbon so no CO₂ generation. In practice the carbon fraction is supposed to come back underground, while leaving just the H₂ portion to emerge and being used in the industrial processes;
a further direct use of the carbon mass can be in a meltshop typically associated to a DRP. An Electric Arc Furnace (EAF) of the meltshop supposed to melt the DRI often needs for technological reasons a certain quantity of carbon in the molten bed bath in order to provide energy, reduction of residual oxides and enough foamy slag volume to allow a smooth operation of the furnace. The same can be considered for alternative melting furnaces (submerged arc furnaces, open slag bath melting furnaces, induction furnaces, etc.);
in some embodiments of the invention, a further direct use of the carbon mass can be at the product discharge of the plant 10 itself: since the produced DRI is lacking carbon content from the melting furnace perspective, a fraction of the carbon separated by the hydrogen generator 31 can be mixed, by a mixer 39, with the DRI discharged hot from the reactor 11 in order to produce Hot Briquetted Iron (known as HBI) with the preferred carbon content. In this way, the ultimate carbon addition to produce steel in the EAF is done in a more efficient way, preventing loss of carbon through the waste gases of the melting furnace. In other embodiments of the invention, some of the carbon mass produced in the hydrogen generator 31 can be fed directly to the DRI or HBI melting unit.

It is clear that modifications and/or additions of parts and steps may be made to the plant and method for the production of direct reduced iron as described heretofore, without departing from the field and scope of the present invention, as defined by the claims.

It is also clear that, although the present invention has been described with reference to some specific examples, a person of skill in the art shall certainly be able to achieve many other equivalent forms of a plant and method for the production of direct reduced iron, having the characteristics as set forth in the claims and hence all coming within the field of protection defined thereby.

In the following claims, the sole purpose of the references in brackets is to facilitate reading and they must not be considered as restrictive factors with regard to the field of protection defined by the same claims.

1. A direct reduction plant for a direct reduction of iron oxides to produce a DRI product, comprising a reactor, configured to being loaded with iron oxides, and reduction circuit fluidically connected to said reactor, wherein said reduction circuit comprises:
a recovery and treatment line, placed downstream of said reactor for recovering and treating an exhaust gas exiting said reactor,
a treatment and feeding line, placed upstream of said reactor, for feeding a process gas, comprising said exhaust gas previously treated and a make-up gas, to said reactor,
a hydrogen generator able to generate said make-up gas,
wherein said hydrogen generator is configured to receive hydrocarbons as a feed and generate, in absence of oxidant agents, both said make-up gas, that comprises hydrogen gas, and a product comprising carbon in solid phase.

2. Plant as in claim 1, wherein said hydrogen generator comprises a reaction chamber where a cracking reaction occurs, a fuel feeder device configured to feed a hydrocarbon fuel to said reaction chamber, an energy feeder device configured to provide energy to said reaction chamber, and/or a catalyst feeder device configured to provide a catalyst to said reaction chamber.

3. Plant as in claim 2, wherein said energy feeder device can be chosen in a group comprising a burner configured to burn part of the fuel or part of the produced hydrogen, a solar device configured to concentrate solar power in said reaction chamber, an electric device both for the indirect heating of the fuel or to directly enhance the reaction in said reaction chamber.

4. Plant as in claim 2, wherein said catalyst feeder device can be chosen in a group comprising a solid metal catalyst feeder, a carbonaceous catalyst feeder, a molten metal feeder, a molten salt feeder.

5. Plant as in claim 1, wherein comprises a mixer device placed downstream of said reactor for mixing part of said product comprising carbon with the hot DRI product.

6. Plant as in claim 1, wherein said treatment and feeding line comprises a heating unit placed upstream of said reactor to heat the process gas at a desired process temperature.

7. Plant as in claim 1, wherein said treatment and feeding line comprises a reformer device configured to receive both said exhaust gas, previously treated and compressed, and to provide, as an outcome, said process gas to be sent to said reactor.

8. A direct reduction method for a direct reduction of iron oxides to produce a DRI product, comprising the following steps:
loading a reactor with said iron oxides,
recovering and treating an exhaust gas exiting said reactor,
treating and feeding a process gas to said reactor, said process gas being a mix of said exhaust gas, previously treated, and a make-up gas generated by a hydrogen generator,
wherein said hydrogen generator receives hydrocarbons as a feed and generate, in absence of oxidant agents, said make-up gas, that comprises hydrogen gas, and a product comprising carbon in solid phase.

9. Method as in claim 8, wherein said make-up gas is generated by cracking of a hydrocarbons-containing gas or liquid.

10. Method as in claim 8, wherein said make-up gas is generated by cracking of natural gas.

11. Method as in claim 8, wherein said product comprising carbon is a raw material suitable for mechanical construction.

12. Method as in claim 8, wherein said product comprising carbon is stored in order to avoid emissions of carbon dioxide to the environment.

13. Method as in claim 8, wherein said hydrogen generator uses natural gas or any combustible gas or liquid to provide energy for the cracking reactions.

14. Method as in claim 8, wherein said hydrogen generator (31) uses part of the produced hydrogen to provide energy for the cracking reactions.

15. Method as in claim 8, wherein said hydrogen generator uses electric energy to provide energy for the cracking reactions.

16. Method as in claim 8, wherein said product comprising carbon is used, in part, inside an electric arc furnace in order to provide the correct blending for the desired steel production.

17. Method as in claim 8, wherein said product comprising carbon is used, in part, at the reactor discharge to provide a desired quantity of carbon to the DRI product.

18. Method as in claim 8, wherein a correct carbon mass of said product comprising carbon is mixed with the DRI product by compressing, in hot or cold conditions, in order to produce HBI products or CBI products.
